(19) United States
(12) Patent Application Publication
(10) Pub. No.: US 2025/0192163 A1
(43) Pub. Date: Jun. 12, 2025

(54) NEGATIVE ELECTRODE CONTAINING CRUSHED CONDUCTIVE ADDITIVE FOR ALL-SOLID-STATE BATTERY AND A METHOD OF MANUFACTURING THE SAME

(71) Applicants: HYUNDAI MOTOR COMPANY, Seoul (KR); KIA CORPORATION, Seoul (KR)

(72) Inventors: Jae Seok Nam, Suwon-si (KR); Hong Suk Choi, Hwaseong-si (KR); Seon Hwa Kim, Cheongju-si (KR); So Yeon Kim, Suwon-si (KR); Dong Hyun Cho, Hwaseong-si (KR); Jae Min Lim, Suwon-si (KR); Hee Soo Kang, Seoul (KR)

(73) Assignees: HYUNDAI MOTOR COMPANY, Seoul (KR); KIA CORPORATION, Seoul (KR)

(21) Appl. No.: 18/807,387

(22) Filed: Aug. 16, 2024

(30) Foreign Application Priority Data
Dec. 6, 2023 (KR) 10-2023-0175068

(51) Int. Cl. H01M 4/38; H01M 4/02; H01M 4/62; H01M 10/0562

(52) U.S. Cl. CPC H01M 4/386; H01M 4/622; H01M 4/625; H01M 10/0562; H01M 2004/021; H01M 2004/027; H01M 2300/0068

(57) ABSTRACT

A negative electrode for an all-solid-state battery and a method of manufacturing the same are provided. The negative electrode includes a conductive additive crushed using a resonance vibration method.

### CROSS REFERENCE TO RELATED APPLICATION

The present application claims priority to Korean Patent Application No. 10-2023-0175068, filed Dec. 6, 2023, the entire contents of which are incorporated herein by reference.

### TECHNICAL FIELD

The present disclosure relates to a negative electrode for an all-solid-state battery, the negative electrode containing a conductive additive crushed using a resonance vibration method, and to a method of manufacturing the same.

### BACKGROUND

A negative electrode for an all-solid-state battery is a composite containing silicon-based negative electrode active materials, sulfide-based solid electrolytes, or the like. A sulfide-based solid electrolyte in a negative electrode is responsible for lithium-ion conduction. When increasing the content of a sulfide-based solid electrolyte to secure a lithium-ion conduction path, an electron conduction path for a silicon-based negative electrode active material is blocked. For this reason, the use of a conductive additive is essential in obtaining output characteristics.

However, conductive additives are prone to aggregation and isolation in the process of manufacturing negative electrodes, so the degree of improving electronic conductivity is insignificant compared to the amount added. Additionally, conductive additives may keep negative electrodes from being densely formed, leading to a decrease in energy density.

### SUMMARY

Therefore, to increase the energy density and output of an all-solid-state battery including a negative electrode containing a silicon-based negative electrode active material and a sulfide-based solid electrolyte, there is a need for an appropriate technique of dispersing conductive additives.

An objective of the present disclosure is to provide a negative electrode for an all-solid-state battery, the electrode containing a uniformly dispersed conductive additive.

Another objective of the present disclosure is to provide a negative electrode for an all-solid-state battery, where an electron conduction path is well established.

Objectives of the present disclosure are not limited to the objectives mentioned above. The above and other objectives of the present disclosure should become more apparent from the following description and the appended claims.

According to an embodiment of the present disclosure, a negative electrode for an all-solid-state battery is provided. The negative electrode includes a negative electrode active material. The negative electrode additionally includes a solid electrolyte, a crushed conductive additive, and a binder. The negative electrode satisfies 0.1<a/b [μm/%]<0.5, where “a” is a particle size D₅₀ of the crushed conductive additive expressed in micrometers (μm) and “b” is a porosity of the negative electrode expressed as a percentage (%).

The negative electrode active material may include a silicon-based negative electrode active material.

The crushed conductive additive may include carbon black.

The crushed conductive additive may have the particle size D₅₀ in a range of 1 μm to 20 μm.

The negative electrode may have the porosity in a range of 0.1% to 70%.

The negative electrode active material may have a particle size D₅₀ in a range of 1 μm to 50 μm.

The solid electrolyte may have a particle size D₅₀ in a range of 0.1 μm to 10 μm.

A ratio (D₁/D₂) of the particle size D₅₀ (D₁) of the solid electrolyte to the particle size D₅₀ (D₂) of the negative electrode active material may be 1 or lower.

According to another embodiment of the present disclosure, a method of manufacturing a negative electrode for an all-solid-state battery is provided. The method includes preparing a starting material by mixing a pristine conductive additive and a crushing medium. The method also includes obtaining a crushed conductive additive by crushing the starting 5 material using a resonance vibration method. The method additionally includes preparing a mixture containing the crushed conductive additive, a negative electrode active material, a solid electrolyte, and a binder. The method further includes manufacturing a negative electrode using the mixture.

A ratio (M₁/M₂) of a mass (M₁) of the pristine conductive additive to a mass (M₂) of the crushing medium may be higher than 0.125 and lower than 8.

Obtaining the crushed conductive additive may include applying a resonance vibration frequency of higher than 0 Hz and lower than 100 Hz to the starting material.

Obtaining the crushed conductive additive may include applying a gravitational acceleration in a range of 20 G to 80 G to the starting material.

Obtaining the crushed conductive additive may include applying a gravitational acceleration to the starting material for more than 2 minutes and less than 10 minutes.

According to embodiments of the present disclosure, a negative electrode for an all-solid-state battery is provided, where the negative electrode includes a uniformly dispersed conductive additive.

According to embodiments of the present disclosure, a negative electrode for an all-solid-state battery is provided, where an electron conduction path is well established.

Effects of the present disclosure are not limited to the effects mentioned above. It should be understood that the effects of the present disclosure include all the effects that can be deduced from the following description.

### BRIEF DESCRIPTION OF THE DRAWINGS

FIG. 1 illustrates an all-solid-state battery, according to an embodiment of the present disclosure;

FIG. 2 illustrates a negative electrode, according to an embodiment of the present disclosure;

FIG. 3 illustrates one example of a crushing process using a resonance vibration method, according to an embodiment of the present disclosure;

FIG. 4A illustrates a scanning electron microscope (SEM) analysis of a negative electrode according to Example 1;

FIG. 4B illustrates an energy-dispersive X-ray spectroscopy (EDS) analysis of a negative electrode according to Example 1;

FIG. 5A illustrates an SEM analysis of a negative electrode according to Comparative Example 3;

FIG. 5B illustrates EDS analysis of a negative electrode according to Comparative Example 3;

FIG. 6 illustrates the charge and discharge characteristics of all-solid-state batteries according to Examples 1 and 2 and Comparative Examples 1 and 2; and

FIG. 7 illustrates the capacity retention rate of the all-solid-state batteries according to Examples 1 and 2 and Comparative Examples 1 and 2.

### DETAILED DESCRIPTION

The above objectives, and other objectives, features, and advantages of the present disclosure should be readily understood from the embodiments described below and the accompanying drawings. However, the present disclosure is not limited to the embodiments described herein and may be embodied in other forms. The embodiments described herein are provided so that the disclosure is thorough and complete and that the spirit of the present disclosure is fully conveyed to those having ordinary skill in the art to which the present disclosure pertains. Throughout the drawings, like elements are denoted by like reference numerals. In the accompanying drawings, the dimensions of the structures are larger than actual sizes for clarity of the present disclosure. Terms such as “first,” “second,” etc., used herein may be used to describe various components, but the components should not be construed as being limited to the terms. These terms are used only for the purpose of distinguishing a component from another component. For example, without departing from the scope of the present disclosure, a first component may be referred to as a second component, and a second component may be also referred to as a first component.

As used herein, the singular forms “a,” “an,” and “the” are intended to include the plural forms as well unless the context clearly indicates otherwise. It should be further understood that the terms “comprises,” “includes,” “has,” or the like, when used herein specify the presence of stated features, regions, integers, steps, operations, elements, and/or components. These terms do not preclude the presence or addition of one or more other features, regions, integers, steps, operations, elements, components, and/or combinations thereof. It should also be understood that when an element such as a layer, film, area, or sheet is referred to as being “on” another element, the element may be directly on the other element, or one or more intervening elements may be present therebetween. Similarly, when an element such as a layer, film, area, or sheet is referred to as being “under” another element, the element may be directly under the other element, or one or more intervening elements may be present therebetween.

Unless otherwise specified, all numbers, values, and/or representations that express the amounts of components, reaction conditions, polymer compositions, and mixtures used herein should be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

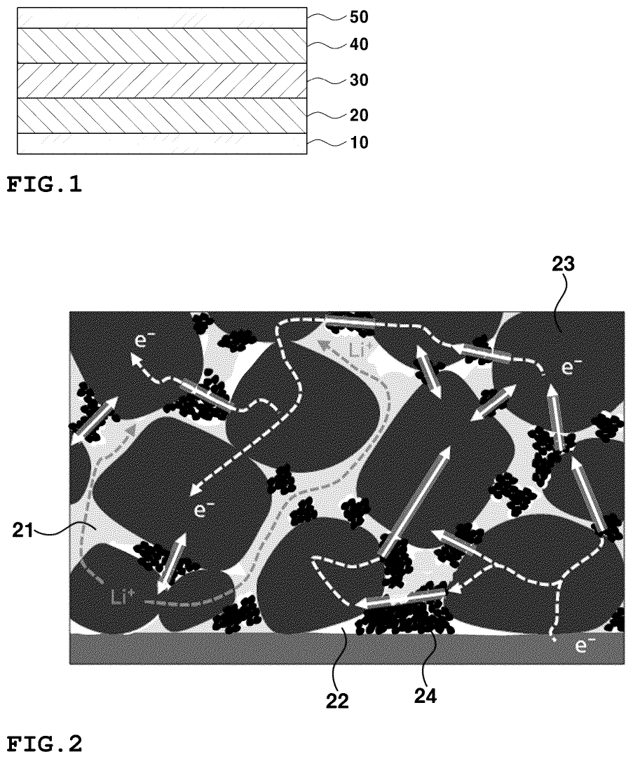

FIG. 1 illustrates an all-solid-state battery, according to an embodiment of the present disclosure. The all-solid-state battery may include a negative electrode current collector 10. The all-solid-state battery may also include a negative electrode 20 disposed on the negative electrode current collector 10. The all-solid-state battery may additionally include a solid electrolyte layer 30 disposed on the negative electrode 20. The all-solid-state battery may further include a positive electrode 40 disposed on the solid electrolyte layer 30. The all-solid-state battery may also include a positive electrode current collector 50 disposed on the positive electrode 40.

The negative electrode current collector 10 may be an electrically conductive substrate having a plate-like form. For example, the negative electrode current collector 10 may have a form of a sheet, thin film, or foil.

The thickness of the negative electrode current collector 10 is not particularly limited but may be, for example, in a range of 1 μm to 500 μm.

The negative electrode current collector 10 may contain copper (Cu), nickel (Ni), stainless steel, and the like.

FIG. 2 illustrates the negative electrode 20, according to an embodiment of the present disclosure. The negative electrode 20 may comprise a negative electrode active material 21, a solid electrolyte 22, a crushed conductive additive 23, a binder (not shown), and the like. The negative electrode 20 may have pores 24, i.e., gaps between each configuration.

The negative electrode active material 21 may include at least one of a silicon-based negative electrode active material, a carbon-based negative electrode active material, or a combination thereof.

The silicon-based negative electrode active material may include at least one of silicone (Si), silicon oxide (SiOₓ) (0<x<2), a Si-containing alloy, or combinations thereof. The Si-containing alloy may include an alloy of Si and at least one element from among an alkali metal, an alkaline earth metal, a Group 13 element, a Group 14 element, a transition metal, a rare-earth element, or a combinations thereof.

The carbon-based negative electrode active material may be graphite, such as mesocarbon microbeads (MCMB) and highly oriented graphite (HOPG), or amorphous carbon, such as hard carbon and soft carbon.

The negative electrode active material 21 may be a composite of the silicon-based negative electrode active material and the carbon-based negative electrode active material. For example, the surface of the carbon-based negative electrode active material may be coated with the silicon-based negative electrode active material. As another example, the surface of the silicon-based negative electrode active material may be coated with the carbon-based negative electrode active material.

The negative electrode active material 21 may have a particle size D₅₀ in a range of 1 μm to 50 μm. The particle size D₅₀ corresponds to a 50% cumulative volume particle size in a volume-based cumulative particle size distribution curve. The method of measuring the particle size D₅₀ is not particularly limited. For example, a sample is irradiated with ultrasound using a laser diffraction-type particle size distribution measuring device for dispersion. Then, the particle size distribution is measured, and a volume-based cumulative particle size distribution curve is obtained. In the above cumulative particle size distribution curve, the particle size D₅₀ may be regarded as the 50% cumulative volume particle size.

The solid electrolyte 22 may include at least one of an oxide-based solid electrolyte, a sulfide-based solid electrolyte, or a combination thereof. In addition, the solid electrolyte 22 may be crystalline, amorphous, or in a combined form thereof.

Examples of the oxide-based solid electrolyte may include a perovskite-type LLTO (Li₃ₓLa_{2/3-x}TiO₃), a phosphate-based NASICON-type LATP (Li₁₊ₓAlₓTi₂₋ₓ(PO₄)₃), or the like.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one among germanium (Ge), zinc (Zn), or gallium (Ga)), Li₂S—GeS₂, Li₂S—SiS₂—Li₃PO₄, Li₂S—SiS₂—LiₓMO_{y} (where x and y are each independently a positive integer, and M is one among phosphorus (P), Si, Ge, boron (B), aluminum (Al), Ga, and indium (In)), Li₁₀GeP₂S₁₂, or the like.

The solid electrolyte 22 may include a sulfide-based solid electrolyte having an argyrodite crystal structure. The sulfide-based solid electrolyte having the argyrodite crystal structure may include at least of Li_{7-y}PS_{6-y}Ha_{y} (where Ha includes chlorine (Cl), bromine (Br), or iodine (I), and 0<y≤2), Li_{7-z}PS_{6-z} (Ha1_{1-b}Ha_{2b})_{z} (where Ha1 and Ha2 are different from each other and each independently includes Cl, Br, or I, 0<b<1, and 0<z≤2), or a combination thereof.

The solid electrolyte 22 may have a particle size D₅₀ in a range of 0.1 μm to 10 μm.

A ratio (D₁/D₂) of the particle size D₅₀ (D1) of the solid electrolyte 22 to the particle size D₅₀ (D₂) of the negative electrode active material 21 may be 1 or lower. When the ratio (D₁/D₂) is 1 or lower, the formation of lithium-ion conduction and electron transfer paths in the negative electrode 20 may easily occur.

The crushed conductive additive 23 may mean the resulting product obtained by crushing a pristine conductive additive using a predetermined method. The crushed conductive additive 23, an electronically conductive material, may include carbon black. For example, the conductive additive 23 may include Super-p, Super-C65, Denka black, Ketjen black, acetylene black, or the like.

The crushed conductive additive 23 may have a particle size D₅₀ in a range of 1 μm to 20 μm. Additionally, the negative electrode 20 may satisfy Equation 1 below.

$$0.1 < a / b [ μm / \% ] < 0.5 \qquad [ Equation 1 ]$$

In Equation 1, “a” may be the particle size D₅₀ [μm] of the crushed conductive additive 23, and “b” may be the porosity [%] of the negative electrode 20. The porosity may be a ratio of the pores 24 contained in a unit volume. The method of measuring the porosity is not particularly limited. For example, after measuring the true density of the negative electrode 20 by a gas displacement method (Pyknometer method) or liquid displacement method (Archimedes method), the thin film density of the negative electrode 20 is calculated using the following equation.

$$Porosity [ \% ] = ( true density - thin film density ) / true density \times 100.$$

The porosity may be calculated using the true density and thin film density using the following equation.

$$Thin film density = weight of negative electrode 20 / ( film thickness of negative electrode 20 \times area ) .$$

When the negative electrode 20 satisfies Expression 1, the crushed conductive additive 23 may offset a disadvantage in that the electron conduction path is blocked by the pores 24. When Equation 1 is satisfied, the crushed conductive additive 23 may be uniformly dispersed in the negative electrode 20 without aggregating and thus form the electron conduction path.

The negative electrode 20 may have a porosity in a range of 0.1% to 70%, 0.1% to 40%, or 0.1% to 30%.

Examples of the binder may include butadiene rubber (BR), nitrile butadiene rubber (NBR), hydrogenated nitrile butadiene rubber (HNBR), polyvinylidene fluoride (PVDF), polytetrafluoroethylene (PTFE), carboxymethyl cellulose (CMC), or the like. The binder in the negative electrode 20 may be present in a particle-like form, a linear form, or the like.

A method of manufacturing the negative electrode 20 may include preparing a starting material by mixing a pristine conductive additive and a crushing medium. The method may also include obtaining a crushed conductive additive by crushing the starting material using a resonance vibration method. The method may further include preparing a mixture containing the crushed conductive additive, a negative electrode active material, a solid electrolyte, and a binder. The method may additionally include manufacturing a negative electrode using the mixture.

The crushing medium is not particularly limited but may, for example, include zirconia balls or the like.

The starting material may be prepared by introducing the crushing medium and the pristine conductive additive into a container with a predetermined internal space and mixing the introduced crushing medium and pristine conductive additive. A ratio (M₁/M₂) of the mass (M₁) of the pristine conductive additive to the mass (M₂) of the crushing medium may be higher than 0.125 and lower than 8. When the ratio (M₁/M₂) falls within the above numerical range, the pristine conductive additive may be effectively crushed.

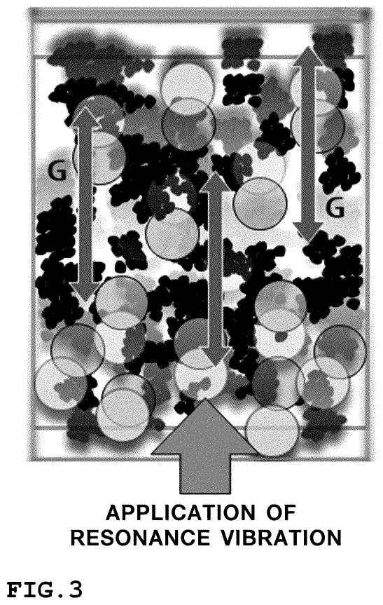

The crushed conductive additive may be obtained by crushing the starting material using the resonance vibration method. FIG. 3 illustrates one example of a crushing process using the resonance vibration method. Resonance vibration-based crushing may involve mixing and crushing by applying acoustic energy and vibration energy to a sample. As shown in FIG. 3, when the sample vertically oscillates, the sample is irradiated with a subharmonic beam such that Faraday waves are exhibited, thus providing strong shear force and collision force to the sample.

Specifically, in the step of obtaining the crushed conductive additive, a resonance vibration frequency of higher than 0 Hz and lower than 100 Hz may be applied to the starting material. At the same time, in the step of obtaining the crushed conductive additive, a gravitational acceleration in a range of G to 80 G may be applied to the starting material for more than 2 minutes and less than 10 minutes.

The crushed conductive additive, obtained in such a manner, may be mixed with the negative electrode active material, the solid electrolyte, and the binder to obtain the mixture. Then, using the mixture, the negative electrode may be manufactured.

The method of obtaining the mixture is not particularly limited. For example, the crushed conductive additive, the negative electrode active material, the solid electrolyte, the binder, and the like may be introduced into a solvent that does not react with each component and then stirred to obtain a mixture in a slurry form.

The method of manufacturing the negative electrode 20 is not particularly limited. For example, the slurry-form mixture may be applied and dried on a substrate to manufacture the negative electrode 20.

The solid electrolyte layer 30 may have a sheet form having at least two main surfaces facing each other. Each of the two main surfaces may be a plane in mathematics, and a part thereof may also uniformly include a curved surface. Alternatively, protrusions and depressions formed during the formation of the solid electrolyte layer 30 may be included. In this regard, the sheet form is not limited to a relatively thin cuboid form.

In the sheet-form solid electrolyte layer 30, a distance between the two main surfaces facing each other may be a thickness of the solid electrolyte layer 30. The length of a first direction (for example, a width direction) perpendicular to the thickness direction of the solid electrolyte layer 30 is larger than the thickness thereof. Additionally, the length of a second direction (for example, a length direction) orthogonal to both the thickness direction of the solid electrolyte layer 30 and the first direction is larger than the thickness thereof.

The thickness of the solid electrolyte layer 30 is not particularly limited but may be in a range of 1 μm to 100 μm. The thickness of the solid electrolyte layer 30 may mean an average value obtained when measuring a measurement target at five points.

The solid electrolyte layer 30 may contain a solid electrolyte having lithium-ion conductivity, a binder, and the like.

The solid electrolyte may be the same as or different from the solid electrolyte contained in the negative electrode 20. The solid electrolyte may include at least one of an oxide-based solid electrolyte, a sulfide-based solid electrolyte, or a combination thereof. Additionally, the solid electrolyte may be crystalline, amorphous, or in a combined form thereof. The oxide-based solid electrolyte and the sulfide-based solid electrolyte may be the same as those described above.

Examples of the binder may include butadiene rubber (BR), nitrile butadiene rubber (NBR), hydrogenated nitrile butadiene rubber (HNBR), polyvinylidene fluoride (PVDF), polytetrafluoroethylene (PTFE), carboxymethyl cellulose (CMC), or the like. The binder in the solid electrolyte layer 30 may be present in a particle-like form, a linear form, or the like.

The positive electrode 20 may contain a positive electrode active material, a solid electrolyte, a conductive additive, a binder, and the like.

The positive electrode active material may include a lithium transition metal oxide configured to store and release lithium.

The lithium transition metal oxide may include any material common in the art to which the present disclosure pertains. For example, the lithium transition metal oxide may include LiNiₓ₁Coₓ₂Mnₓ₃O₂ (0.65≤x1≤0.85, 0.05<x2<0.25, 0.03<x3<0.2, and x1+x2+x3=1).

The particle size D₅₀ of the positive electrode active material is not particularly limited but may be, for example, in a range of 1 μm to 20 μm.

The positive electrode active material may be coated with an alkali metal oxide.

The alkali metal oxide may comprise an alkali metal element, a transition metal element, and a substitution element.

The alkali metal element may include at least one of lithium (Li), sodium (Na), potassium (K), or combinations thereof. In an embodiment, the alkali metal element includes lithium (Li).

The transition metal element may include any alkali metal oxide commonly used in the art to which the present disclosure pertains. For example, the transition metal element may include at least one of niobium (Nb), tantalum (Ta), zirconium (Zr), or combinations thereof.

The solid electrolyte may be responsible for lithium-ion movement in the positive electrode 40. The solid electrolyte may be the same as or different from the solid electrolyte of the negative electrode 20 and the solid electrolyte layer 30. The solid electrolyte may include at least one of an oxide-based solid electrolyte, a sulfide-based solid electrolyte, or a combination thereof. Additionally, the solid electrolyte may be crystalline, amorphous, or in a combined form thereof. The oxide-based solid electrolyte and the sulfide-based solid electrolyte are the same as those described above.

Examples of the conductive additive may include carbon black, conductive graphite, ethylene black, graphene, carbon nanotubes, carbon nanofibers, vapor-grown carbon fibers, or the like.

Examples of the binder may include butadiene rubber (BR), nitrile butadiene rubber (NBR), hydrogenated nitrile butadiene rubber (HNBR), polyvinylidene fluoride (PVDF), polytetrafluoroethylene (PTFE), carboxymethyl cellulose (CMC), or the like. The binder in the positive electrode 40 may be present in a particle-like form, a linear form, or the like.

The positive electrode 40 may contain 70 percentage by weight (wt %) to 90 wt % of the positive electrode active material, 10 wt % to 15 wt % of the solid electrolyte, 1 wt % to 5 wt % of the conductive additive, and 1 wt % to 5 wt % of the binder. However, the content of each component may be appropriately adjusted in consideration of the capacity and efficiency of the desired all-solid-state battery.

The thickness of the positive electrode 40 is not particularly limited but may be in a range of 1 μm to 100 μm. The thickness of the positive electrode 40 may mean an average value obtained when measuring a measurement target at five points. Additionally, the thickness of the positive electrode 40 may mean the thickness of the all-solid-state battery in a discharged state.

The positive electrode current collector 50 may include an electrically conductive substrate having a plate-like form. For example, the positive electrode current collector 10 may have a form of a sheet, thin film, or foil.

The positive electrode current collector 50 may include an aluminum foil.

The thickness of the positive electrode current collector 50 is not particularly limited but may be, for example, in a range of 1 μm to 500 μm.

Another embodiment of the present disclosure is described in more detail below through the following examples. The following examples are merely examples provided to enhance the understanding of the present disclosure. The scope of the present disclosure is not limited thereto.

### Example 1

A pristine conductive additive was crushed using a resonance vibration method to obtain a crushed conductive additive having a particle size D₅₀ of about 8 μm. After preparing a slurry containing the crushed conductive additive, a silicon-based negative electrode active material, a sulfide-based solid electrolyte, and a binder, the slurry was applied and dried on a negative electrode current collector to manufacture a negative electrode. The porosity of the negative electrode and whether Expression 1 is satisfied are shown in Table 1. A nickel foil having a thickness of about 10 μm was used as the negative electrode current collector.

A solid electrolyte layer having a thickness in a range of about 30 μm to 50 μm was stacked on the negative electrode.

A positive electrode and a positive electrode current collector were stacked on the solid electrolyte layer to obtain an all-solid-state battery. The loading amount of a positive electrode active material in the positive electrode was about 24 mg/cm², and an aluminum foil having a thickness of about 12 μm was used as the positive electrode current collector.

An N/P ratio in the all-solid-state battery was adjusted to be about 1.2.

### Example 2

An all-solid-state battery was manufactured in the same manner as in Example 1, except for varying the particle size D₅₀ of the pristine conductive additive and the porosity of the negative electrode, as shown in Table 1.

### Comparative Example 1

An all-solid-state battery was manufactured in the same manner as in Example 1, except for varying the particle size D₅₀ of the pristine conductive additive and the porosity of the negative electrode, as shown in Table 1.

### Comparative Example 2

An all-solid-state battery was manufactured in the same manner as in Example 1, except for varying the particle size D₅₀ of the pristine conductive additive and the porosity of the negative electrode, as shown in Table 1.

### Comparative Example 3

An all-solid-state battery was manufactured in the same manner as in Example 1, except for using the pristine conductive additive instead of the crushed conductive additive.

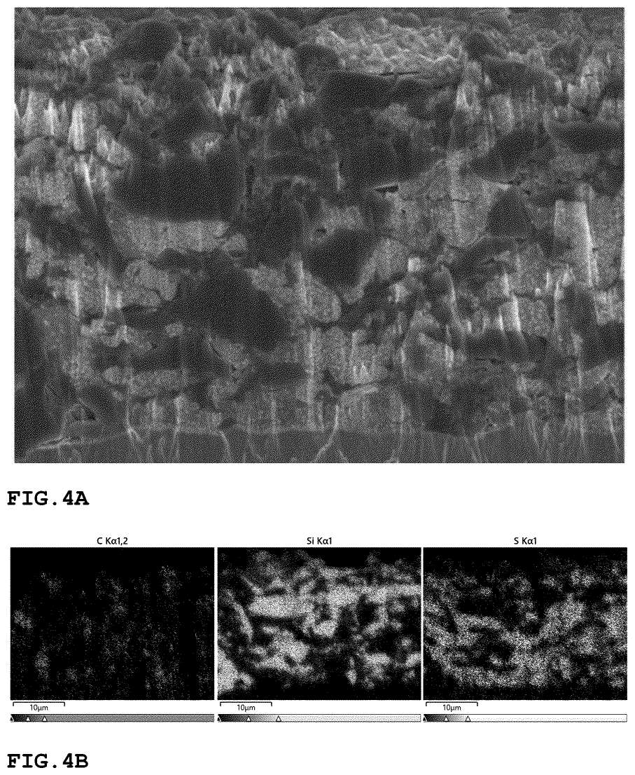

FIG. 4A illustrates an analysis result of the negative electrode according to Example 1, wherein the analysis is performed with a scanning electron microscope (SEM). FIG. 4B illustrates analysis results of the negative electrode according to Example 1, wherein the analysis performed with energy-dispersive X-ray spectroscopy (EDS).

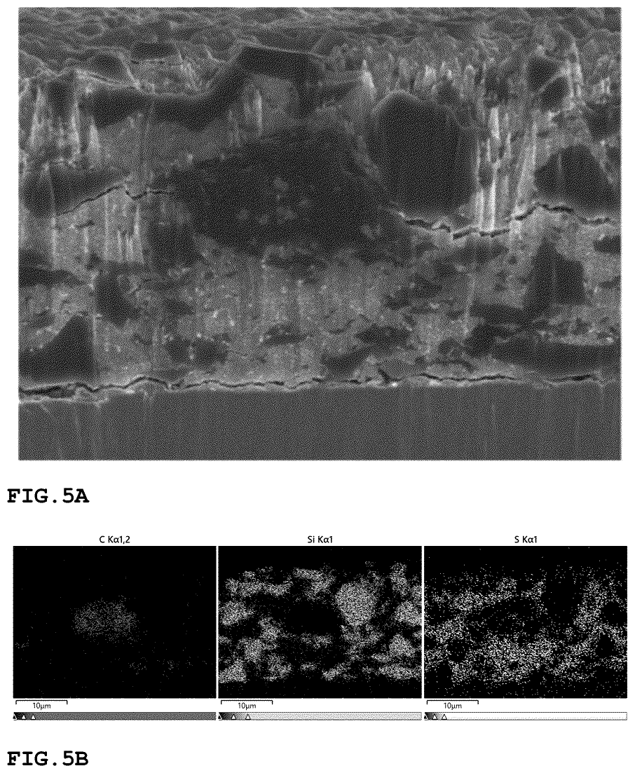

FIG. 5A illustrates an SEM analysis result of the negative electrode according to Comparative Example 3. FIG. 5B illustrates EDS analysis results of the negative electrode according to Comparative Example 3.

From the results described above, it can be seen that in Example 1, the crushed conductive additive is uniformly distributed in the negative electrode, while the pristine conductive additive in Comparative Example 3 aggregates.

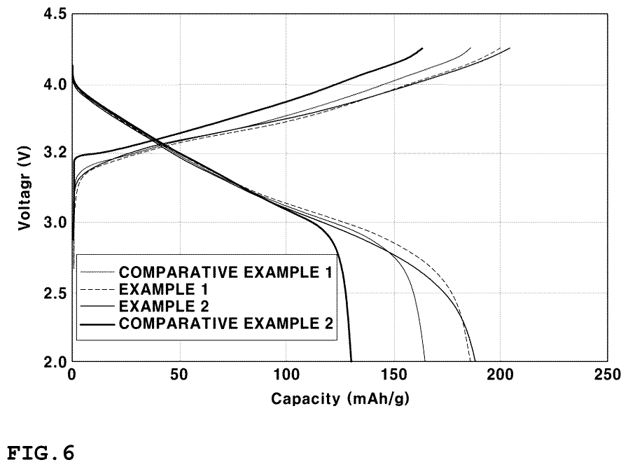

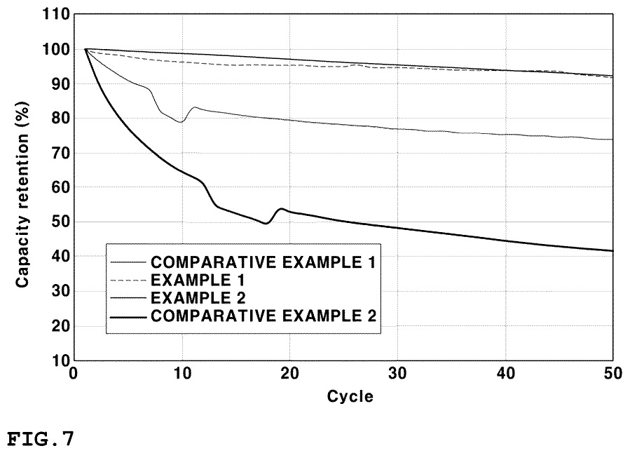

FIG. 6 illustrates evaluation results of the charge and discharge characteristics of the all-solid-state batteries according to Examples 1 and 2 and Comparative Examples 1 and 2. FIG. 7 illustrates evaluation results of the capacity retention rate of the all-solid-state batteries according to Examples 1 and 2 and Comparative Examples 1 and 2. Each of the all-solid-state batteries was charged and discharged under the following conditions: a temperature of about 30° C., a voltage level in a range of 2.0 to 4.25 V; and a charging rate of 0.2 C.

TABLE 1

| | Comparative | | | Comparative |
|---|---|---|---|---|
| Item | Example 1 | Example 1 | Example 2 | Example 2 |
| Particle size D₅₀ | 15 | 8 | 3 | 1 |
| of crushed | | | | |
| conductive | | | | |
| additive [μm] | | | | |
| Porosity of | 25 | 23 | 21 | 20 |
| negative | | | | |
| electrode [%] | | | | |
| Value of Equation | 0.6 | 0.35 | 0.14 | 0.05 |
| 1¹⁾ | | | | |
| Initial | 85.2 | 92.5 | 92.4 | 84.2 |
| efficiency [%] | | | | |
| DC-IR [Ω] | 33.5 | 21.8 | 17.5 | 28.1 |
| Capacity | 73.9 | 91.3 | 91.0 | 40.3 |
| retention rate at | | | | |
| 50 cycles [%] | | | | |

[Equation 1] 0.1<a/b [μm/%]<0.5, where “a” is the particle size D₅₀ [μm] of the crushed conductive additive, and “b” is the porosity [%] of the negative electrode.

From FIGS. 6 and 7 and Table 1, it can be seen that both the initial efficiency and capacity retention rate in the case of Examples 1 and 2 are superior to those in the case of Comparative Examples 1 and 2.

While the present disclosure has been shown and described with reference to embodiments thereof, it should be understood that the scope of the present disclosure is not limited to the described embodiments. Modified forms are also included within the scope of the present disclosure.

What is claimed is:

1. A negative electrode for an all-solid-state battery, the negative electrode comprising:
a negative electrode active material;
a solid electrolyte;
a crushed conductive additive; and
a binder,
wherein the negative electrode satisfies
$$0.1 < a / b [ μm / \% ] < 0.5 ,$$
wherein a is a particle size D₅₀ of the crushed conductive additive expressed in micrometers (μm) and b is a porosity of the negative electrode expressed as a percentage (%).

2. The negative electrode of claim 1, wherein the negative electrode active material comprises a silicon-based negative electrode active material.

3. The negative electrode of claim 1, wherein the crushed conductive additive comprises carbon black.

4. The negative electrode of claim 1, wherein the crushed conductive additive has the particle size D₅₀ in a range of 1 μm to 20 μm.

5. The negative electrode of claim 1, wherein the negative electrode has the porosity in a range of 0.1% to 70%.

6. The negative electrode of claim 1, wherein the negative electrode active material has a particle size D₅₀ in a range of 1 μm to 50 μm.

7. The negative electrode of claim 1, wherein the solid electrolyte has a particle size D₅₀ in a range of 0.1 μm to 10 μm.

8. The negative electrode of claim 1, wherein a ratio (D₁/D₂) of a particle size D₅₀ (D₁) of the solid electrolyte to a particle size D₅₀ (D₂) of the negative electrode active material is 1 or lower.

9. A method of manufacturing a negative electrode for an all-solid-state battery, the method comprising:
preparing a starting material by mixing a pristine conductive additive and a crushing medium;
obtaining a crushed conductive additive by crushing the starting material;
preparing a mixture comprising the crushed conductive additive, a negative electrode active material, a solid electrolyte, and a binder; and
manufacturing a negative electrode using the mixture, wherein the negative electrode satisfies
$$0.1 < a / b [ μm / \% ] < 0.5 ,$$
wherein a is a particle size D₅₀ of the crushed conductive additive expressed in micrometers (μm) and b is a porosity of the negative electrode expressed as a percentage (%).

10. The method of claim 9, wherein a ratio (M₁/M₂) of a mass (M₁) of the pristine conductive additive to a mass (M₂) of the crushing medium may be higher than 0.125 and lower than 8.

11. The method of claim 9, wherein obtaining the crushed conductive additive includes crushing the starting material using a resonance vibration method.

12. The method of claim 9, wherein obtaining the crushed conductive additive includes applying a resonance vibration frequency of higher than 0 Hz and lower than 100 Hz to the starting material.

13. The method of claim 9, wherein obtaining the crushed conductive additive includes crushing the starting material by applying a gravitational acceleration in a range of 20 G to 80 G.

14. The method of claim 9, wherein obtaining the crushed conductive additive includes crushing the starting material by applying a gravitation acceleration for more than 2 minutes and less than 10 minutes.

15. The method of claim 9, wherein the crushed conductive additive comprises carbon black.

16. The method of claim 9, wherein the crushed conductive additive has a particle size D₅₀ in a range of 1 μm to 20 μm.

17. The method of claim 9, wherein the negative electrode has the porosity in a range of 0.1% to 70%.

18. The method of claim 9, wherein the negative electrode active material has a particle size D₅₀ in a range of 1 μm to 50 μm.

19. The method of claim 9, wherein the solid electrolyte has a particle size D₅₀ in a range of 0.1 μm to 10 μm.

20. The method of claim 9, wherein a ratio (D₁/D₂) of a particle size D₅₀ (D₁) of the solid electrolyte to a particle size D₅₀ (D₂) of the negative electrode active material is 1 or lower.
